(19) United States
(12) Patent Application Publication
(10) Pub. No.: US 2011/0228375 A1
(43) Pub. Date: Sep. 22, 2011

(54) LASER ILLUMINATION MODULE WITH INTEGRATED INTENSITY MODULATOR

(75) Inventor: Shahyaan Desai, Ithaca, NY (US)

(73) Assignee: Mezmeriz, Inc., Ithaca, NY (US)

(21) Appl. No.: 13/046,371

(22) Filed: Mar. 11, 2011

Related U.S. Application Data
(60) Provisional application No. 61/313,238, filed on Mar. 12, 2010.

(51) Int. Cl. G02F 1/05

(52) U.S. Cl. 359/245

(57) ABSTRACT

The present application is directed towards, among other things, systems and methods for modulating the intensity of laser light at high frequencies for use in projection systems. A laser is modulated by an electro-optical device, such as an intensity modulator, that can change its reflective or transmissive behavior at rates exceeding tens of megahertz under the application of an electric field. In some embodiments, the intensity modulator may be configured as a Fabry-Pérot interferometer or etalon, or a Gires-Tournois etalon. In many embodiments, the intensity modulator may include a transparent relaxor-ferroelectric-type material between the modulator's reflective plates. By applying a voltage to the ferroelectric material, its refractive index may be varied to dynamically change the resonance of the modulator, modulating the intensity of the light transmitted through or reflected from the modulator. The intensity modulator may be placed in various configurations to modulate the laser through transmission, reflection, or phase delay and recombination.

### RELATED APPLICATION

The present application claims priority to U.S. Application No. 61/313,238, entitled “Laser Illumination Module with Integrated Intensity Modulator” and filed Mar. 12, 2010, the contents of which are hereby incorporated by reference in their entirety.

### BACKGROUND

Laser illumination modules coupled with micromirrors that can scan laser light in two orthogonal directions have been used to provide simple, highly miniaturizable and inexpensive portable image projection systems. Due their small size and capabilities, these microelectromechanical system (MEMS) based projectors may be utilized in various devices, from laptop computers to personal digital assistants or smart phones.

However, one major drawback to laser illumination in these systems is the difficulty in producing a directly modulatable diode laser emitting at 488-540 nm wavelengths, which acts as the source of green color in a red, green, and blue based color projection system. While red and blue lasers are inexpensively available with intensity modulation capabilities in excess of tens of megahertz, currently, there exist no equally capable inexpensive green lasers.

Diode pumped solid state lasers (DPSS) using a frequency doubling system to convert 1064 nm IR wavelengths to 532 nm green light are inexpensively available, but are typically limited to less than 10 kHz intensity modulation rates. Directly modulatable frequency doubled green lasers also exist, but require complex optical materials and labor intensive fabrication and as such, are too expensive for practical use in an inexpensive portable projection system.

### BRIEF SUMMARY OF THE DISCLOSURE

The present application is directed towards systems and methods for modulating the intensity of laser light at high frequencies for use in miniature projection systems, by way of example. An inexpensive constant wavelength (CW) laser can be modulated by an electro-optical device that can change its reflective or transmissive behavior at rates exceeding tens of megahertz (e.g., about 50 MHz to about 1 GHz), under the application of an electric field. In some embodiments, the electro-optical device may be configured as a Fabry-Pérot interferometer or etalon, or a Gires-Tournois etalon, or a voltage controlled polarization rotator. In many embodiments, the etalon may include a transparent relaxor-ferroelectric-type material between the etalon's reflective plates. By applying a voltage to the ferroelectric material, its refractive index may be varied to dynamically change the resonance of the etalon cavity, modulating the intensity of the light transmitted through or reflected from the etalon. The etalon may be placed in various configurations to modulate the CW laser through transmission, reflection, polarization rotation, or phase delay and recombination.

In one aspect, the present disclosure is directed to a system for producing a laser light with modulated intensity. The system can include a chamber, a ferroelectric material disposed within the chamber, a voltage source coupled to the ferroelectric material, and a laser light source positioned to project laser light through the chamber. The voltage source can apply a voltage to the ferroelectric material to change a refractive index or a rotation of an optical crystal axis of the ferroelectric material at a rate of at least 10 MHz.

The rate can be between about 50 MHz and about 1 GHz. The ferroelectric material can be strontium barium niobate, potassium barium niobate, potassium tantalam niobate, barium titanate, lead barium niobate, barium strontium potassium sodium niobate, or any combination thereof. In some embodiments, the system includes a conductive film disposed in the chamber and coupled to the ferroelectric material. In some embodiments, the voltage source applies the voltage to the ferroelectric material by applying the voltage to the conductive film. The conductive film can include, for example, indium tin oxide or carbon.

In some embodiments, provided systems include a polarizer disposed to receive the laser light projected through the chamber. In some embodiments, provided systems include a mirror that reflects the laser light projected through the chamber such that the laser light combines with laser light from another laser light source. In many embodiments, the mirror can scan the laser light in at least one direction. In some embodiments, the mirror comprises a wavelength selective dichroic mirror. In some embodiments, the mirror can transmit a first portion of the laser light to a second mirror and reflect a second portion of the laser light to the chamber.

A first surface of the chamber can be more reflective than a second surface of the chamber, causing the chamber to reflect the laser light. The system can include a first mirror that reflects a first portion of the laser light from the laser light source to the chamber and a second portion of the laser light from the laser light source to a second mirror. Laser light reflected from the chamber and laser light reflected from the second mirror can combine constructively or destructively, according to the phase delay.

In some embodiments, provided systems include a second chamber and a second ferroelectric material disposed within the second chamber. In some such embodiments, the laser light source can project laser light through the second chamber, and the voltage source can apply a second voltage to the second ferroelectric material to change a refractive index or a rotation of an optical crystal axis of the second ferroelectric material at a rate of at least 10 MHz. The second voltage can be different from the first voltage. In some embodiments, provided systems include a pivot system that rotates one or more chambers.

In some aspects, the present disclosure provides systems for producing a laser light with modulated intensity. In some embodiments, provided systems include a plate, a ferroelectric material with reflective films disposed on surfaces of the ferroelectric material, a voltage source coupled to the ferroelectric material, and a laser light source positioned to project laser light through the plate. In some embodiments, the ferroelectric material is coupled to the plate. The voltage source applies a voltage to the ferroelectric material to change a refractive index or a rotation of an optical crystal axis of the ferroelectric material at a rate of at least 10 MHz.

In some aspects, the present disclosure provides methods of producing a laser light with modulated intensity. In some embodiments, provided methods include projecting laser light through a chamber, and applying a voltage to a ferroelectric material disposed within the chamber to change a refractive index of the ferroelectric material at a rate of at least 10 MHz.

In some embodiments, projecting laser light through a chamber includes or involves causing a phase delay in the laser light. In some embodiments, provided methods include combining the laser light projected through the chamber with laser light projected from a laser light source to cause constructive or destructive interference, according to the phase delay. In some embodiments, provided methods include reflecting the laser light projected through the chamber such that the laser light combines with laser light from another laser light source.

The details of various embodiments of the invention are set forth in the accompanying drawings and the description below.

### BRIEF DESCRIPTION OF THE DRAWING

The foregoing and other objects, aspects, features, and advantages of the invention will become more apparent and better understood by referring to the following description taken in conjunction with the accompanying drawing, in which:

FIG. 1 is a block diagram of an exemplary laser illumination module;

FIG. 2 is a block diagram of an exemplary embodiment of an intensity modulator that can be used in the laser illumination module of FIG. 1;

FIG. 3 is a block diagram of another exemplary embodiment of an intensity modulator that can be used in the laser illumination module of FIG. 1;

FIG. 4 is a block diagram of another exemplary laser illumination module;

FIG. 5 is a block diagram of another exemplary laser illumination module, the module having a pixelated intensity modulator;

FIG. 6A is a block diagram of an embodiment of a laser illumination module employing an intensity modulator in a transmission mode;

FIG. 6B is a block diagram of an embodiment of a laser illumination module employing an intensity modulator in a reflection mode; and

FIG. 6C is a block diagram of an embodiment of a laser illumination module employing an intensity modulator in an interferometer configuration.

The features and advantages of the present invention will become more apparent from the detailed description set forth below when taken in conjunction with the drawing, in which like reference characters identify corresponding elements throughout. In the drawing, like reference numbers generally indicate identical, functionally similar, and/or structurally similar elements.

### DETAILED DESCRIPTION OF CERTAIN EMBODIMENTS

Described below are particular embodiments of systems and methods for integrating an intensity modulator into an illumination module containing red, blue, and green laser light sources for projectors. Although generally described in reference to pico-projectors or small portable projectors, in some embodiments, the systems discussed in this description may be utilized in cellular phones, laptops, tablet computers, personal digital assistants, smart phones, portable video games, or larger image projection systems, including public displays, home or public theaters, or any other video or image display systems.

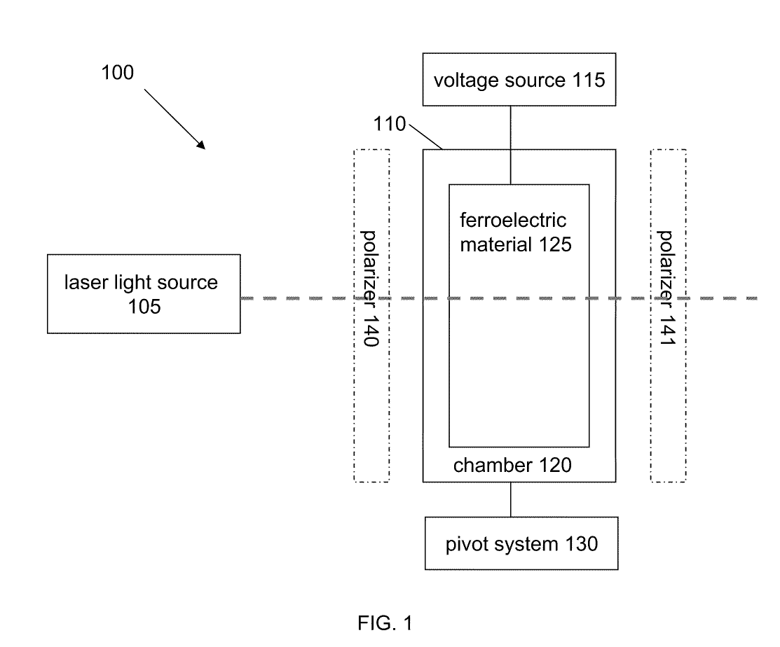

Referring now to FIG. 1, a block diagram of an exemplary laser illumination module 100 is shown and described. As depicted in this FIG. 1, this laser illumination module 100 includes a laser light source 105 (also referred to herein as a laser source), an intensity modulator 110 (also referred to herein as an intensity modulating device, an intensity modulating structure, an etalon modulator structure, or a modulator), and a voltage source 115 coupled to the intensity modulator 110. The intensity modulator 110 can include a chamber 120 with a ferroelectric material 125 disposed therein. The intensity modulator 110 can be attached to a pivot system 130 (e.g., a MEMS based rotatable surface) that rotates the modulator 110 relative to the laser light source 105. The laser illumination module 100 can include optional polarizers 140, 141 positioned on opposite sides of the intensity modulator 110.

In many embodiments, the intensity modulator 110 can be an electro-optical device that can change its reflective or transmissive behavior under the application of an electric field. For example, the voltage source 105 can apply a voltage to the ferroelectric material 125 to change its refractive index, as described in further detail below. In some embodiments, the modulator may change the phase and/or polarization of light passing through or reflecting off the modulator 110, also described in further detail below. In one embodiment, the modulator 110 may be configured as a Fabry-Pérot interferometer or etalon, while in another embodiment, the modulator 110 may be a Gires-Tournois etalon.

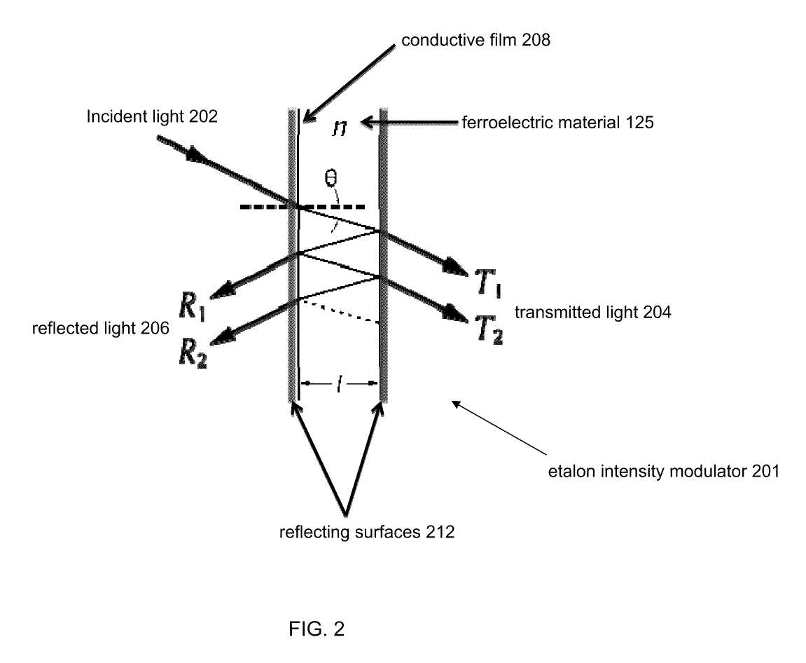

Referring now to FIG. 2, in some embodiments, an etalon intensity modulator structure 201 that can be used for the intensity modulator 110 of FIG. 1 is shown and described. The etalon intensity modulator 201 can include two parallel reflecting surfaces 212 (e.g., mirrors) separated by a distance substantially equal to a multiple of a wavelength of light emitted by the laser light source 105. For surface normal incident light 202, the separation distance and the refractive index of the material 125 between the reflective surfaces 212 determines the ‘resonance’ of the modulator 110—e.g., the precise wavelength of light that will be transmitted through the modulator 110. The varying transmission function of an etalon intensity modulator 201 is caused by interference between the multiple reflections of light between the two reflecting surfaces 212. Constructive interference occurs if the transmitted beams are in phase, and this corresponds to a high-transmission peak of the modulator 201. If the transmitted beams are out-of-phase, destructive interference occurs and this corresponds to a transmission minimum. Whether the multiple reflected beams are in-phase or not depends on the wavelength (λ) of the light (in vacuum), the angle the light travels through the modulator 201 (θ), the thickness of the modulator 201 (l) and the refractive index of the material 125 between the reflecting surfaces 212 (n).

In some embodiments, a transparent relaxor-ferroelectric-type material 125 may be placed between the reflecting surfaces 212. Electro-optical properties of the ferroelectric materials 125 may be used to dynamically change the ‘resonance’ of the modulator 201, changing the levels of light that is transmitted through or reflected from the modulator 201. This may be accomplished by applying a voltage to the ferroelectric material 125, which causes a change in its refractive index proportional to the square of the applied voltage (called the electro-optical Kerr effect). In various embodiments, the ferroelectric material can be strontium barium niobate, potassium barium niobate, potassium tantalum niobate, barium titanate, lead barium niobate, or barium strontium potassium sodium niobate. Other exemplary ferroelectric materials can include lead magnesium niobate, lead zirconate titanate, polyvinylidene flouride, lanthanum doped lead zirconium titanate, or other ferroelectric materials and/or polymers. In further embodiments, combinations of a plurality of ferroelectric materials 125 may be utilized to further vary the resonance of the modulator 201.

In some embodiments, voltage may be applied to ferroelectric material 125 via a transparent conductive film 208 coupled to ferroelectric material 125. Exemplary materials for such a conductive film can include indium tin oxide or carbon.

As discussed above, the angle the light travels through the etalon intensity modulator 201 (θ) affects the transmission function of the modulator 201. Although shown in FIG. 2 at a non-orthogonal angle, in many embodiments, the modulator 201 may be placed orthogonal to incident light 202. In other embodiments, the modulator 201 may be placed at various angles to incident light 202, increasing the amount of internal reflection and attenuation within the modulator 201. The pivot system 130 can dynamically vary the angle of the etalon intensity modulator 201, or any other modulator used for the intensity modulator 110. Because the angle of incidence can affect the etalon modulator structure's 201 efficiency, the pivot system 130 can allow a user of the laser illumination module 100 to manually adjust the modulator 201. Further, any component of the laser illumination module 100 can have imperfections or other non-uniformities from the fabrication process. By adjusting the modulator 201 to an angle where the modulator 201 performs efficiently despite its non-uniformities, the user can use the pivot system 130 to compensate for the characteristics of the modulator 201.

In some embodiments, by dynamically changing the electro-optical properties of the ferroelectric material 125 as discussed above, the ratio of transmitted light 204 to reflected light 206 may be accordingly adjusted from 0:1 to 1:0, subject to attenuation within the materials of the etalon intensity modulator 201. For monochromatic light such as that from a DPSS 532 nm laser, the modulator 201 can thus act as an intensity modulator. For example, in one embodiment, if the modulator 201 is designed to have a transmission peak at 532 nm when no voltage is applied, almost all the laser light passes through the modulator 201. Upon the application of voltage, the change in the refractive index of the ferroelectric material 125 shifts the transmission peak of the modulator 201 so that it no longer peaks at 532 nm, but is now at a slightly higher wavelength. This permits only some fraction of the laser light to be transmitted while the rest is reflected. Larger applied voltages and subsequently larger changes in refractive index cause greater shifts in the transmission/reflection spectrum of the modulator 201, resulting in lower transmission and greater reflection of the 532 nm laser light. Accordingly, the modulator 201 can thus be used as a reflection or transmission mode intensity modulator for monochromatic 532 nm laser light. In other embodiments, the modulator 201 may be designed to have transmission peaks at other wavelengths, for use modulating lasers of other colors. In still other embodiments, the modulator 201 may be designed to have a transmission peak at a lower wavelength, such that when voltage is applied, the transmission peak shifts up to the frequency of the laser source. Accordingly, in some embodiments, the modulator 201 may transmit incident light when under no voltage, while in other embodiments, the modulator 201 may reflect incident light when under no voltage. This may be beneficial in transmission vs. reflection mode configurations, discussed in more detail below.

In another embodiment, the etalon intensity modulator 201 may be placed to modulate monochromatic light prior to its entry to a second harmonic generator. For example, a DPSS laser source that emits a 1064 nm wavelength beam may employ a second harmonic generator to generate a desired 532 nm green beam. In some embodiments, the modulator 201 may be designed to have transmission peaks at or below 1064 nm, as discussed above, such that the modulator 201 may be used to modulate the 1064 nm beam prior to entering the second harmonic generator. Accordingly, in some embodiments, the DPSS green laser module may thus include an integrated etalon intensity modulator 201 using the techniques described below.

In some embodiments, the efficiency of the etalon and its reflection/transmission characteristics may be improved with the use of Bragg reflectors as the reflecting surfaces 212. The Bragg reflectors can include layers of transparent materials (e.g. films) placed adjacent to one another, the layers alternating between materials of high and low refractive indices. The thickness of each layer can be a multiple of the wavelength of light from the laser light source 105. In some embodiments, the layers have uniform thickness, whereas in other embodiments, the layers have different thicknesses. The Braggs reflectors can include any number of layers of any thicknesses. When light crosses a boundary between layers, part of the light is internally reflected. Constructive interference between reflected rays of light creates a higher intensity ray that is reflected. In various embodiments, Bragg reflectors may be formed with a photonic stopband centered on the wavelength of the laser, such as 532 nm for DPSS green lasers.

In other embodiments, volume holograms may also be used as both or one of the reflective surfaces 212 of the etalon intensity modulator 201. Volume holograms selectively transmit wavelengths of light. A volume hologram can include layers of materials (e.g. transparent films) or two-dimensional diffraction grating. The layers and/or diffraction grating can be created by etching, embossing, or recording a diffraction pattern using a laser such that only the wavelength of laser light used to create the pattern will be transmitted through the pattern. In these embodiments, the phase angle of the hologram may automatically compensate for optical thickness variations in the ferroelectric material 125 and/or the modulator 201, permitting higher yields and more accurate reflection/transmission of precise spectra.

In some embodiments, the modulator 201 or 110 may be formed on transparent substrates such as glass and sapphire, or on silicon or other semiconductors. In a further embodiment of forming the modulator 201 or 110 on silicon, electronic circuits used to modulate the modulator 201 or 110 may be directly integrated within the modulator 201 or 110, e.g., fabricated on the same substrate as the chamber 120 of the modulator 201 or 110.

Typically, beams emitted from DPSS lasers at the output face of the laser are on the order of 100 μm to 500 μm. An etalon intensity modulator 201 would therefore need to have an aperture large enough to accommodate such a beam. If designed as a single monolithic element, the capacitance of the ferroelectric material 125, and the resistance of the electrodes through which voltage is applied to the material 125 determine the modulator's 201 switching speed. The total power consumed by the modulator 201 is also a function of the square of the frequency at which the modulator 201 is operated.

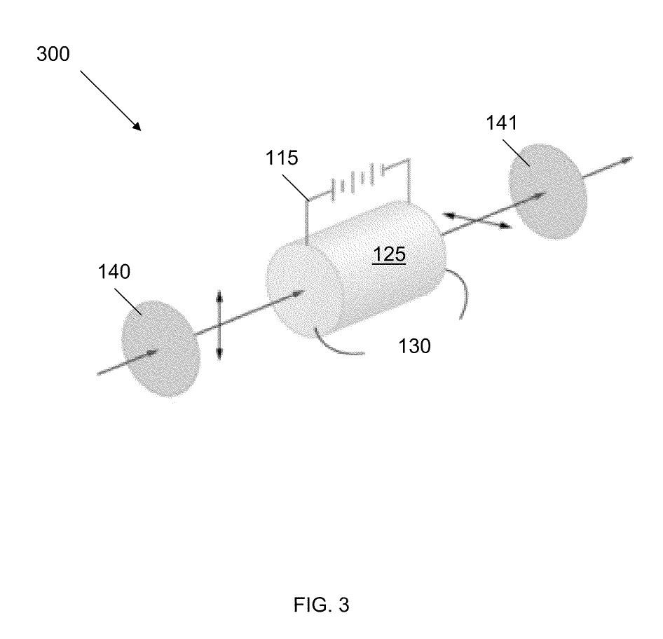

Referring now to FIG. 3, a block diagram of an exemplary embodiment 300 of an intensity modulator, polarizers, and voltage source that can be used in the laser illumination module of FIG. 1 is shown and described. A polarizer 140 (also referred to herein as an input polarizer) can be disposed to receive light from the laser light source 105. The input polarizer 140 can polarize light according to the orientation of the polarizer's 140 optical crystal axis and transmit the light to the ferroelectric material 125. The ferroelectric material 125 can rotate the polarized light as the light propagates through the material 125, according to the material's 125 optical axis.

A polarizer 141 (also referred to herein as an output polarizer) can receive the light from the ferroelectric material 125. The output polarizer 141 can transmit or block polarized light based on the polarization of the light relative to the optical crystal axis of the polarizer 141. If the polarization of the light matches the polarizer's 141 axis, the polarizer 141 transmits all of the light. If the polarization is orthogonal to the polarizer's 141 axis, the polarizer 141 blocks all the light from passing through. For other angles between the light's polarization and the polarizer's 141 optical axis, the polarizer 141 can allow a partial transmission of light.

In various embodiments, a voltage source 115 of the laser illumination module 300 can apply a voltage to the ferroelectric material 125 via electrodes 130 (e.g., transparent electrodes). The voltage can rotate the material's 125 optical axis. The magnitude of the applied voltage, the length of the ferroelectric material 125, or both can affect the magnitude of the rotation. For example, in some embodiments, the rotation of the optical axis of the ferroelectric material 125 can be proportional to a function of the length of the material 125 and the magnitude of the applied voltage.

In this manner, the voltage from the voltage source 115 can control the intensity of light transmitted through the modulator 110 and polarizers 140, 141. For example, the input and output polarizers 140, 141 can be oriented to transmit vertically polarized light. The ferroelectric material 125 can be oriented to transmit vertically polarized light. Thus, when the voltage source 115 does not apply a voltage to the ferroelectric material 125, all the light projected from the laser light source 105 can be transmitted through the polarizers 140, 141 and the intensity modulator 110.

The voltage source 115 can rotate the ferroelectric material's 125 optical axis such that the output polarizer 141 transmits a partial amount of light received from the material 125 or blocks the light entirely. For example, when the voltage source 115 applies a voltage to rotate the optical axis of the ferroelectric material 125 by ninety (90) degrees, light that passes through the input polarizer 140 and the material 125 is polarized horizontally. Because an output polarizer 141 oriented to transmit vertically polarized light blocks horizontally polarized light, the polarizer 141 can block all light received from the ferroelectric material 125.

When the voltage source 115 applies a voltage to rotate the optical axis by any other angle, the polarizer 141 partially transmits the light according to the angle between the polarized light and the polarizer's 141 optical axis. As the angle decreases, the polarizer 141 can transmit a larger proportion of light received from the ferroelectric material 125. In this manner, the modulator 110 can modulate the intensity of transmitted light by applying a voltage to the ferroelectric material 125.

The polarizers 140, 141 can be oriented in any manner as would be appreciated by one of ordinary skill in the art. In this embodiment, the optical axes of the polarizers 140, 141 align. In other embodiments, the optical axis of the output polarizer 141 can be orthogonal to the optical axis of the input polarizer 140.

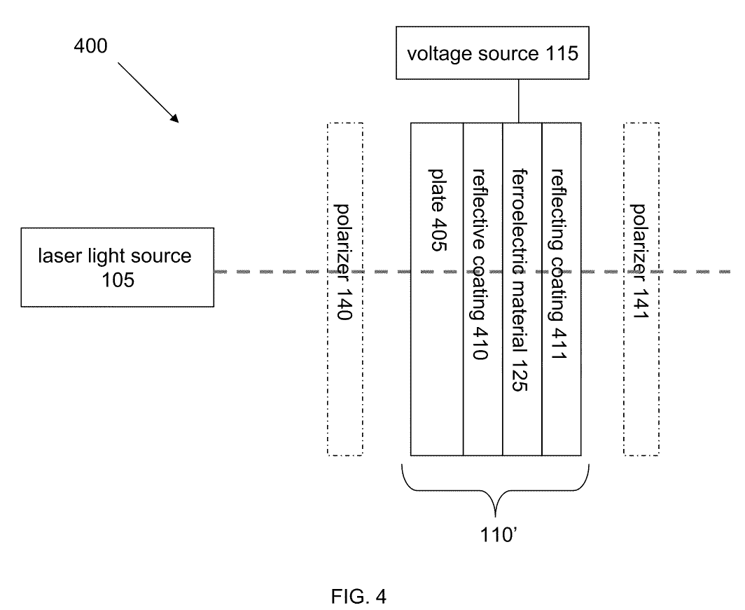

Referring now to FIG. 4, a block diagram of another exemplary laser illumination module 400 is shown and described. The laser illumination module 400 includes the laser light source 105, voltage source 115, and optional polarizers 140, 141 of laser illumination module 100. The module 400 uses a different intensity modulator 110′. The modulator 110′ includes a single plate 405 (e.g., a transparent plate) adhered to the ferroelectric material 125. Reflecting coatings 410, 411 (e.g., reflective films) can be deposited on opposite surfaces of the ferroelectric material 125. The voltage source 115 can apply a voltage to the ferroelectric material 125 to change the refractive index of the material 125.

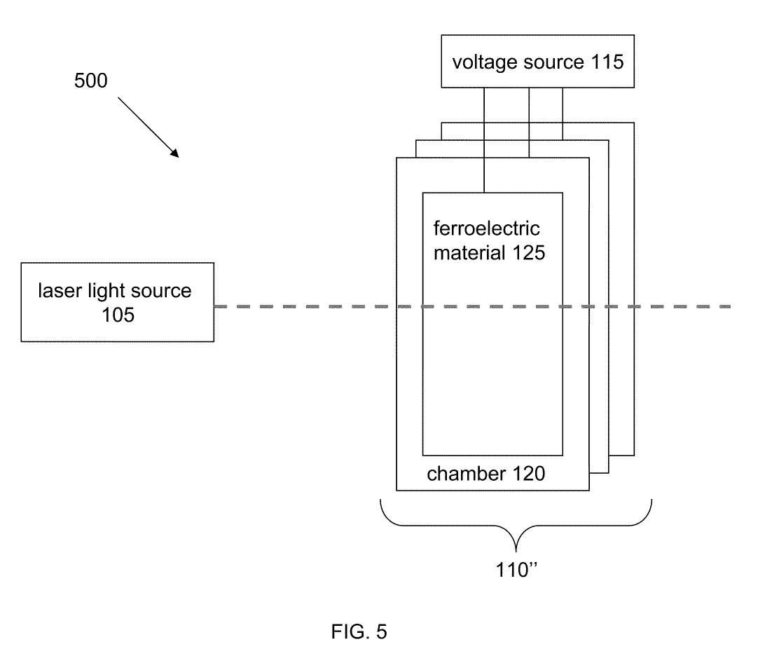

Referring now to FIG. 5, a block diagram of an exemplary laser illumination module 500 with a pixelated etalon intensity modulator 110″ is shown and described. Such a module 500 can be used to lower the switching speed of the modulator. The pixelated etalon modulator 110″ can include a plurality of smaller modulators. The modulators can be arranged in a one- or two-dimensional array. The modulators can match or circumscribe the aperture of the light projected from the laser light source 105. For example, for a laser light source 105 projecting a beam of light with a 1 mm diameter, a pixelated etalon modulator 110″ can include a 10×10 array of square etalon modulators (e.g., each corresponding to a pixel), each square modulator measuring 10 μm on each side. In this manner, each modulator modulates, at most, 1% of the light. The voltage source 115 can connect to the modulators to apply a voltage to their ferroelectric materials 125. In some embodiments, the voltage source 115 can apply different voltages to different modulators to control the intensity of transmitted light. The capacitance and resistance of each pixel would be much smaller than that of a monolithic etalon resulting in faster modulating speeds. Furthermore, grey scale control of the laser intensity may be improved using such a pixelated etalon modulator.

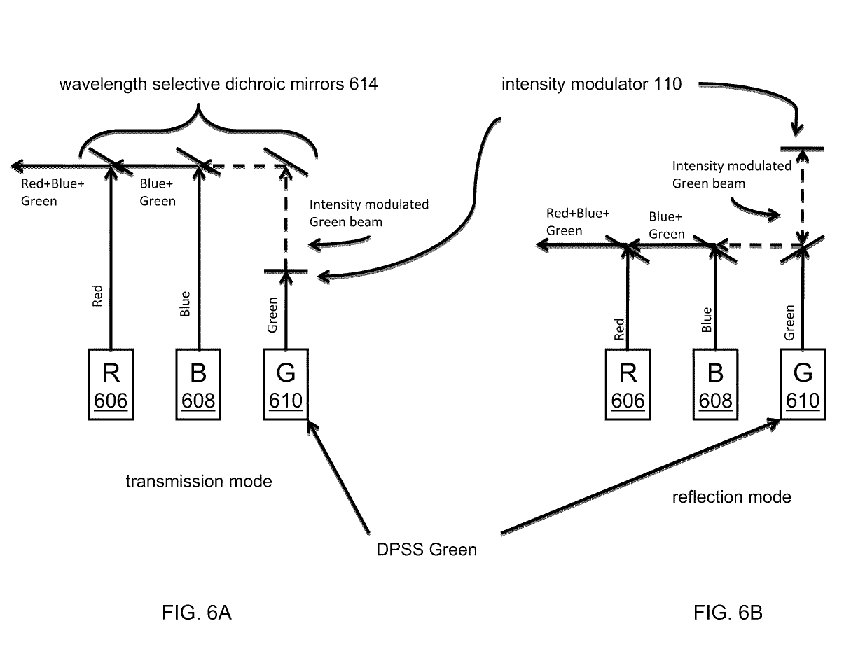

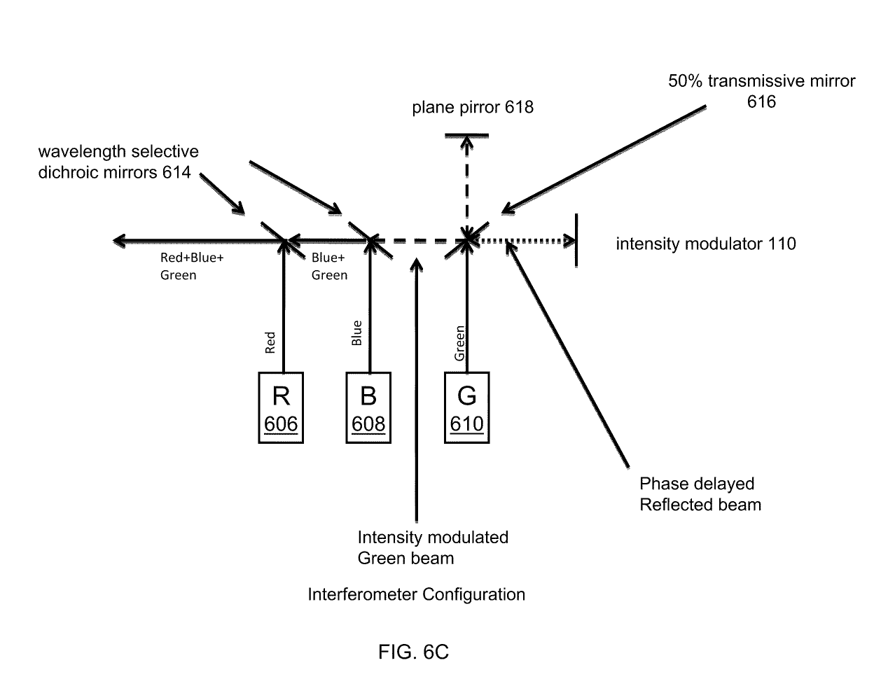

Referring now to FIGS. 6A-6C, block diagrams of exemplary embodiments of a laser illumination module employing an etalon modulator in a transmission mode, a reflection mode, and an interferometer configuration, respectively, are shown and described. Referring first to FIG. 6A, an exemplary embodiment of a laser illumination module operating in a transmission mode is shown and described. In some embodiments, the laser illumination module comprises a red laser source 606, a blue laser source 608, and a green laser source 610. In many embodiments, red laser source 606 and blue laser source 608 may be directly modulated at high frequencies. As discussed above, this may be cost-prohibitive for green laser source 610, which may instead be an unmodulated or CW laser source. However, in other embodiments not illustrated, red laser source 606 and/or blue laser source 608 may also be unmodulated sources, and may be modulated via an etalon modulator as discussed above. In some embodiments, the laser illumination module may include one or more wavelength selective dichroic mirrors 614. Each mirror 614 may be selected to reflect a corresponding red, blue, or green beam while transmitting other colors as shown. Accordingly, the red, blue, and green beams may be combined for transmitting to a scanning mirror or other module of a projection system.

In embodiments of laser illumination modules operating in a transmission mode as shown in FIG. 6A, an intensity modulator 110 is placed directly in the path of the beam from the green laser source 610. As discussed above, in some embodiments, the intensity modulator 110 may be designed to have a transmission peak at 532 nm when no voltage is applied, such that the green light may be fully transmitted, subject to internal attenuation. A change in the transmitted wavelength results in the modulation of the green beam. In many embodiments, because the intensity modulator 110 must be fabricated on transparent substrates (e.g., glass, quartz, fused silica, sapphire) to allow the beam to pass through, an external circuit may be required to apply voltage to the modulator 110.

Referring now to FIG. 6B, a block diagram of an exemplary embodiment of a laser illumination module operating in a reflection mode is shown and described. In these embodiments, an intensity modulator 110 is placed within the module so that the light from the green laser source 610 strikes the modulator prior to being combined with the light from the red and blue lasers 606 and 608. By selectively changing the reflectivity of all or parts of the modulator via application of voltage as discussed above in connection with FIG. 2, the intensity of the green beam relative to the red and blue beams can be controlled. These embodiments need not require the intensity modulator 110 to be fabricated on transparent substrates, such as silicon. In some embodiments as shown in FIG. 6B, the beam from green laser source 610 may cross the same mirror as it is reflected from. Accordingly, in some embodiments, a half-silvered mirror or beam splitter may be used to allow both transmission and reflection. In other embodiments, a material or combination of materials may be selected for the mirror or the mirror may be fabricated with geometries such that the green beam is initially transmitted through the mirror, but is reflected by the other side of the mirror after being modulated. In still other embodiments, the green laser source 610, mirror and intensity modulator 110 may not be oriented in a straight line. For example, in one such embodiment, the laser source 610 may be above the mirror such that the beam from source 610 to the intensity modulator 110 passes above the mirror. In another such embodiment, the laser source 610 may be oriented to one side of the mirror such that the beam from source 610 to modulator 110 passes beside the mirror, while the reflected beam from the modulator 110 strikes the mirror.

Referring now to FIG. 6C, an exemplary embodiment of a laser illumination module in an interferometer configuration is shown and described. In this embodiment, the intensity modulator 110 is a Gires-Tournois etalon, designed so that the mirror below the ferroelectric film (or opposite the incident light) is more reflective than the mirror coating the ferroelectric film (or on the same side as incident light), due to the materials used for the mirror and the thickness thereof. Light incident on the etalon undergoes a phase delay after passing through the mirror, ferroelectric film and bottom mirror. The amount of phase delay can be controlled by changing the refractive index of the ferroelectric film via the application of voltage, in effect forming a phase modulator. As shown in FIG. 6C, the phase modulator is placed in a Michaelson interferometer configuration. Light from green laser source 610 is split by 50% transmissive mirror 616. One split beam is reflected by plane mirror 618, while the other split beam is reflected from an intensity modulator 110, such as a Gires-Tournois etalon. As a split beam passes through the ferroelectric material of the Gires-Tournois etalon, its speed changes due to the material's refractive index. As a result, the phase of the split beam changes (e.g., the reflected split beam has a phase delay). The split beam with phase delay and the split beam reflected by the plane mirror 218 are recombined. If the phase delay is adjusted such that the recombined beams are perfectly out of phase, destructive interference creates a dark pixel as the two beams cancel each other out. If the phase delay is adjusted such that the recombined beams are perfectly in phase, constructive interference will create a bright spot. Phase shifts in between will create varying brightness in the green beam.

In some embodiments, the laser illumination module may be packaged as a self contained module including standardized control and power inputs, such that the module may be a plug and play module useable by manufacturers and designers of other systems. In other embodiments, the modulator and a laser may be integrated in a single package, such that they may be easily added to existing laser illumination modules in place of one or more lasers.

In many embodiments, the module may include an LCD driver circuit or a modified, higher-voltage LCD driver circuit. For example, in some embodiments of a pixelated etalon modulator using the reflection mode described above, the module may include a matrix of bulk or thin-film transistors (TFT) to modulate the reflectivity of the etalon. In some embodiments, the transistors may be directly integrated into the modulator. In embodiments of a pixelated etalon modulator using the transmission mode described above, the module may include a similar driver circuit external to the etalon with leads connecting the transistors of the transistor circuit to each pixel of the modulator. In other embodiments using a monolithic etalon modulator, the ferroelectric material may be driven by a low-voltage RF driver circuit.

In some embodiments, a system comprising a pico-projector may include an embodiment of a laser illumination module in one of the configurations discussed above and a MEMS scanning mirror module. In many embodiments, the system may also include control electronics. In some embodiments, the laser illumination module may consist of directly modulatable red (600-650 nm) and blue (400-470 nm) diode lasers and a DPSS green laser with an etalon modulator as described above. In other embodiments, an unmodulatable blue diode laser may be combined with a second etalon modulator, using one of the configurations described above.

Color and intensity information of each pixel in an image is encoded by varying the intensity of each laser, either via direct modulation of the current to the laser diode, or by modulating the voltage to the ferroeletric etalon modulator. The three modulated laser beams may be combined into a single beam, using beam-combining optics. In some embodiments, combination of the beams may be accomplished using wavelength selective elements that only transmit or reflect light of specific wavelengths. For example, in one embodiment, the modulated green beam may be reflected by a dichroic mirror designed to reflect only 532 nm wavelength light. In another embodiment, the modulated green beam may be reflected by a standard mirror, if wavelength discrimination is not required. This beam may be transmitted through a mirror that permits 532 nm light to be transmitted but reflects 400-470 nm light from the blue beam. The blue-green beam may then be transmitted through a mirror that transmits 400-580 nm wavelengths, but reflects 600-650 nm red light, as shown in FIGS. 2A-2C. In another embodiment not illustrated, the blue-green beam may be reflected from a mirror that reflects 400-580 nm wavelengths, but transmits 600-650 nm red light. In other embodiments not illustrated, the order of combination of beams may be altered. For example, in one such embodiment, the red beam may be reflected and combined with the blue beam, and then the red-blue beam combined with the green beam. In some embodiments, the combined red-blue-green beam may be aligned to the MEMS scanning mirror module such that the modulated beam strikes the MEMS scanning mirror. The MEMS mirror may then raster scan the combined beam in two dimensions to form a pixelated image on a surface, such as a wall, screen, table, reflective sheet, or other surface. In some embodiments, the control electronics may convert pixel information for the image into current modulation functions for the directly modulatable lasers, such as the red laser, and voltage modulation functions for the etalon modulator used for the green laser. In many embodiments, the control electronics may further control the MEMS mirror actuation and interpret position feedback to keep laser pulses synchronized with the position of the MEMS mirrors.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed:

1. A system for producing a laser light with modulated intensity comprising:
a chamber;
a ferroelectric material disposed within the chamber;
a voltage source coupled to the ferroelectric material; and
a laser light source positioned to project laser light through the chamber;
wherein the voltage source applies a voltage to the ferroelectric material to change a refractive index or a rotation of an optical crystal axis of the ferroelectric material at a rate of at least 10 MHz.

2. The system of claim 1, wherein the rate is between about 50 MHz and about 1 GHz.

3. The system of claim 1, wherein the ferroelectric material is strontium barium niobate, potassium barium niobate, potassium tantalam niobate, barium titanate, lead barium niobate, barium strontium potassium sodium niobate, or any combination thereof.

4. The system of claim 1, further comprising a conductive film disposed in the chamber and coupled to the ferroelectric material, wherein the voltage source applies the voltage to the ferroelectric material by applying the voltage to the conductive film.

5. The system of claim 4, wherein the conductive film is indium tin oxide or carbon.

6. The system of claim 1, further comprising a polarizer disposed to receive the laser light projected through the chamber.

7. The system of claim 1, further comprising a mirror that reflects the laser light projected through the chamber such that the laser light combines with laser light from another laser light source.

8. The system of claim 7, wherein the mirror scans the laser light in at least one direction.

9. The system of claim 7, wherein the mirror is a wavelength selective dichroic mirror.

10. The system of claim 7, wherein the mirror transmits a first portion of the laser light to a second mirror and reflects a second portion of the laser light to the chamber.

11. The system of claim 1, wherein a first surface of the chamber is more reflective than a second surface of the chamber, causing the chamber to reflect laser light.

12. The system of claim 1, further comprising
a first mirror that reflects
a first portion of the laser light from the laser light source to the chamber and
a second portion of the laser light from the laser light source to a second mirror,
wherein laser light reflected from the chamber and laser light reflected from the second mirror combine constructively or destructively, according to the phase delay.

13. The system of claim 1, further comprising:
a second chamber;
a second ferroelectric material disposed within the second chamber;
wherein
the laser light source projects laser light through the second chamber, and
the voltage source applies a second voltage to the second ferroelectric material to change a refractive index or a rotation of an optical crystal axis of the second ferroelectric material at a rate of at least 10 MHz.

14. The system of claim 13, wherein the second voltage is different from the first voltage.

15. The system of claim 1, further comprising a pivot system that rotates the chamber.

16. A system for producing a laser light with modulated intensity comprising:
a plate;
a ferroelectric material with reflective films disposed on surfaces of the ferroelectric material, the ferroelectric material coupled to the plate;
a voltage source coupled to the ferroelectric material; and
a laser light source positioned to project laser light through the plate;
wherein the voltage source applies a voltage to the ferroelectric material to change a refractive index or a rotation of an optical crystal axis of the ferroelectric material at a rate of at least 10 MHz.

17. A method of producing a laser light with modulated intensity comprising:
projecting laser light through a chamber;
applying a voltage to a ferroelectric material disposed within the chamber to change a refractive index of the ferroelectric material at a rate of at least 10 MHz.

18. The method of claim 18, wherein projecting laser light through a chamber further comprises causing a phase delay in the laser light.

19. The method of claim 19, further comprising combining the laser light projected through the chamber with laser light projected from a laser light source to cause constructive or destructive interference, according to the phase delay.

20. The method of claim 18, further comprising reflecting the laser light projected through the chamber such that the laser light combines with laser light from another laser light source.
